(19) United States
(12) Patent Application Publication
(10) Pub. No.: US 2023/0252361 A1
(43) Pub. Date: Aug. 10, 2023

(54) INFORMATION PROCESSING APPARATUS, METHOD AND PROGRAM

(71) Applicant: KABUSHIKI KAISHA TOSHIBA, Tokyo (JP)

(72) Inventors: Yuichi KATO, Moriya Ibaraki (JP); Kentaro TAKAGI, Yokohama Kanagawa (JP); Kouta NAKATA, Tokyo (JP)

(73) Assignee: KABUSHIKI KAISHA TOSHIBA, Tokyo (JP)

(21) Appl. No.: 17/942,992

(22) Filed: Sep. 12, 2022

(30) Foreign Application Priority Data
Feb. 10, 2022 (JP) 2022-019856

(51) Int. Cl. G06N 20/20

(52) U.S. Cl. CPC G06N 20/20

(57) ABSTRACT

According to one embodiment, an information processing apparatus includes a processor. The processor generates a machine learning model by coupling one feature extractor to each of a plurality of predictors, the feature extractor being configured to extract a feature amount of data. The processor trains the machine learning model for a specific task using a result of ensembling a plurality of outputs from the predictors.

### CROSS-REFERENCE TO RELATED APPLICATIONS

This application is based upon and claims the benefit of priority from Japanese Patent Application No. 2022-019856, filed Feb. 10, 2022, the entire contents of which are incorporated herein by reference.

### FIELD

Embodiments described herein relate generally to an information processing apparatus, a method and a program.

### BACKGROUND

In machine learning, it is known that ensembling the predictions of a plurality of models improves accuracy more than predicting a single model. However, the use of a plurality of models requires training and inference for each model, which increases memory and computational costs in proportion to the number of models when training and deployment.

### BRIEF DESCRIPTION OF THE DRAWINGS

FIG. 1 is a block diagram showing an information processing apparatus according to a present embodiment. according to a present embodiment.

FIG. 2 is a flowchart showing an operation example of the information processing apparatus according to the present embodiment.

FIG. 3 is a diagram showing an example of a network structure of a machine learning model according to the present embodiment.

FIG. 4 is a diagram showing a first example of a network structure of the machine learning model when training according to the present embodiment.

FIG. 5 is a diagram showing a second example of a network structure of the machine learning model when training according to the present embodiment.

FIG. 6 is a diagram showing an example of a hardware configuration of the information processing apparatus according to the present embodiment.

### DETAILED DESCRIPTION

In general, according to one embodiment, an information processing apparatus includes a processor. The processor generates a machine learning model by coupling one feature extractor to each of a plurality of predictors, the feature extractor being configured to extract a feature amount of data. The processor trains the machine learning model for a specific task using a result of ensembling a plurality of outputs from the predictors.

Hereinafter, the information processing apparatus, method, and program according to the present embodiment will be described in detail with reference to the drawings. In the following embodiment, the parts with the same reference signs perform the same operation, and redundant descriptions will be omitted as appropriate.

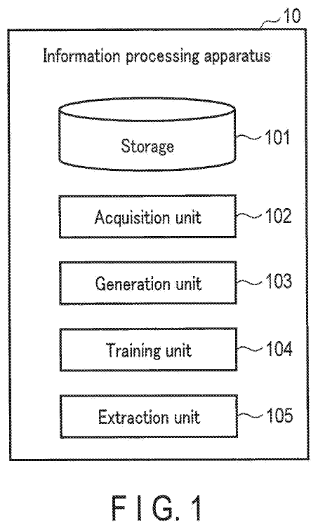

The information processing apparatus according to the present embodiment will be described with reference to a block diagram in FIG. 1.

An information processing apparatus 10 according to a first embodiment includes a storage 101, an acquisition unit 102, a generation unit 103, a training unit 104, and an extraction unit 105.

The storage 101 stores a feature extractor, a plurality of predictors, training data, etc. The feature extractor is a network model that extracts features of data, for example, a model called an encoder. Specifically, the feature extractor assumes a deep network model including a convolutional neural network (CNN) such as ResNet, but any network model used in feature extraction or dimensionality compression, not limited to ResNet, can be applied.

The predictor is assumed to use an MLP (Multi-Layer Perceptron) network model. The training data is used to train a machine learning model to be described later.

The acquisition unit 102 acquires one feature extractor and a plurality of predictors from the storage 101.

The generator 103 generates a machine learning model by coupling one feature extractor to each of the predictors. The machine learning model is formed as a so-called multi-head model in which one feature extractor is coupled to a plurality of predictors.

The training unit 104 trains the machine learning model using the training data. Here, the training unit 104 trains the machine learning model for a specific task using a result of ensembling outputs from the predictors.

Upon completion of the training of the machine learning model, the extraction unit 105 extracts the feature extractor of the machine learning model as a trained model. The extracted feature extractor can be used in downstream tasks such as classification and object detection.

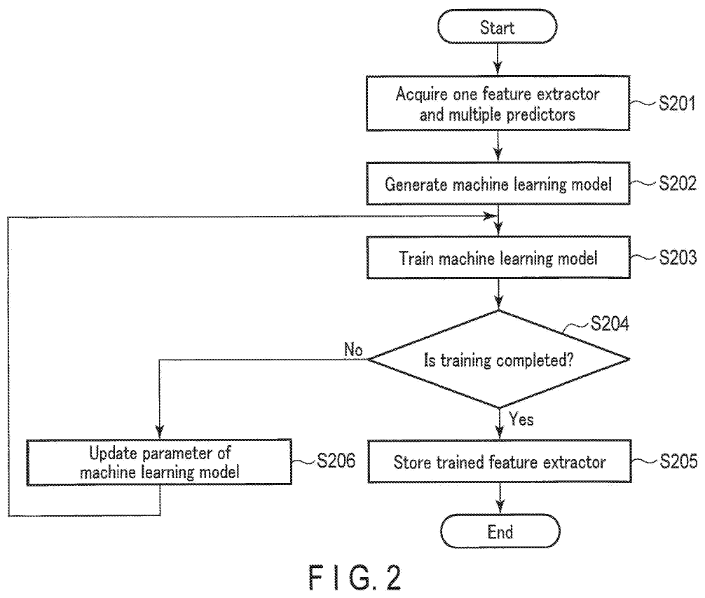

Next, an operation example of the information processing apparatus 10 according to the present embodiment will be described with reference to a flowchart in FIG. 2.

In step S201, the acquisition unit 102 acquires one feature extractor and a plurality of predictors.

In step S202, the generation unit 103 generates a machine learning model by coupling the one feature extractor to each of the predictors. The machine learning model generated in S202 has not yet been trained by the training unit 104.

In step S203, the training unit 104 trains the machine learning model using training data stored in the storage 101. Specifically, a loss function based on an output from the machine learning model for the training data is calculated.

In step S204, the training unit 104 determines whether or not the training of the machine learning model is completed. To determine whether or not the training is completed, for example, it is sufficient to determine that the training is completed if a loss value of the loss function using the outputs from the predictors is equal to or less than a threshold value. Alternatively, the training may be determined to be completed if a decreasing range of the loss value converges. Furthermore, the training may be determined to be completed if training of a predetermined number of epochs is completed. If the training is completed, the process proceeds to step S205, and if the training is not completed, the process proceeds to step S206.

In step S205, the storage 101 stores a trained feature extractor as a trained model.

In step S206, the training unit 104 updates a parameter of the machine learning model, specifically, a weight and bias of a neural network, etc. by means of, for example, a gradient descent method and an error backpropagation method so that the loss value becomes minimum. After updating the parameter, the process returns to step S203 to continue training the machine learning model using new training data.

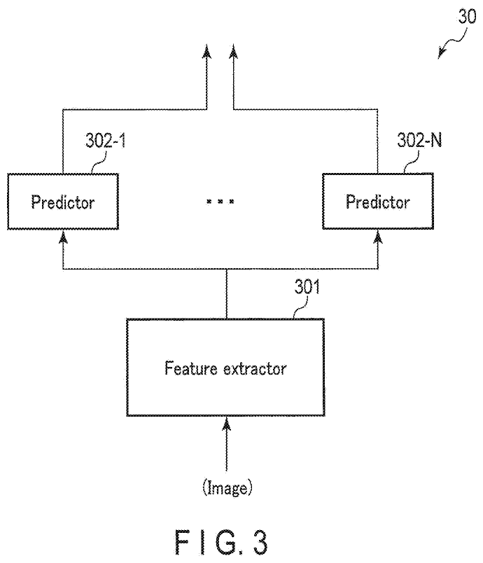

Next, an example of a network structure of the machine learning model according to the present embodiment will be described with reference to FIG. 3.

A machine learning model 30 according to the present embodiment includes one feature extractor 301 and a plurality of predictors (here, N predictors 302-1 to 302-N where N is a natural number of 2 or more). Hereafter, the predictors, when not specifically distinguished, will simply be referred to as the predictor 302. In the examples from FIG. 3 onward, a case is assumed in which an image is input as training data to the machine learning model, but it is not limited thereto, and two-or-more-dimensional data other than images or one-dimensional time-series data such as a sensor value may be used.

As shown in FIG. 3, the N predictors 302-1 to 302-N as heads are each coupled to the feature extractor 301. If an image is input to the feature extractor 301, a feature of the image is extracted by the feature extractor 301 and that feature is input to each of the predictors 302-1 to 302-N. Outputs from the predictors 302-1 to 302-N are used for loss calculation.

Here, the predictors 302-1 to 302-N are each configured differently from each other. For example, it suffices that each of the predictors 302-1 to 302-N differs in at least one of network weight coefficient, number of network layers, number of nodes, or network structure (neural network architecture). In the case of different network structures, for example, one predictor may be an MLP and the others may be CNNs.

Further, the configuration is not limited thereto, and the predictors 302-1 to 302-N may include dropouts so as to have different network structures when training. The predictors 302-1 to 302-N may differ in at least one of number of dropouts, position of dropout, or regularization method such as weight decay. The predictor 302 may include one or more convolutional layers. If there are a plurality of predictors 302 including one or more convolutional layers, a position of a pooling layer may be different between the predictors 302.

The above example assumes that the network structure of each of the predictors 302-1 to 302-N is different, but even if the predictors 302-1 to 302-N have the same structure, different predictors 302-1 to 302-N may be designed by either using different network weight coefficients or by adding noise to the input to each predictor 302, which is the output from the feature extractor 301.

That is, the outputs from the predictors 302-1 to 302-N may be designed to be different from each other. This allows for variation in output from the predictors 302 when training and improves a training effect of the ensemble.

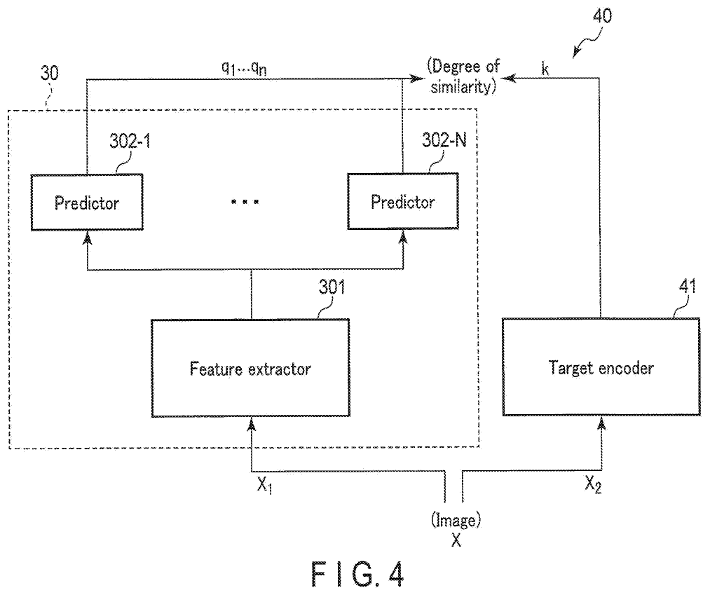

Next, a first example of the network structure of the machine learning model 30 when training is described with reference to FIG. 4.

FIG. 4 assumes that the machine learning model 30 shown in FIG. 3 is trained by self-supervised learning using a so-called BYOL network structure 40. Self-supervised learning is one of the machine learning methods of learning from unlabeled sample data so that identical data (positive examples) are closer (more similar) and different data (negative examples) are farther apart (less similar). In the case of self-supervised learning with BYOL, the model is trained using only positive examples, not negative examples.

The network structure 40 shown in FIG. 4 includes the machine learning model 30 and a target encoder 41. To each of the machine learning model 30 and the target encoder 41, different images based on one image that are obtained by processing one image X using data augmentation are input as training data. Data augmentation processing is processing of generating a plurality of pieces of data based on one image by inverting, rotating, cropping, or adding noise to the image. That is, data-augmented data from one image, such as an image X₁ with an original image inverted and an image X₂ with the original image rotated, are input to the machine learning model 30 and the target encoder 41, respectively.

In the machine learning model 30, image features q₁, . . . , and qₙ (n is a natural number of 2 or more) are output from the predictors 302. On the other hand, an image feature k is output from the target encoder 41. The loss function L of the network structure 40 should be determined based on an ensemble of degrees of similarity between the outputs q₁, . . . , and qₙ from the predictors 302 and the output k from the target encoder 41, and is expressed, for example, in equation (1).

$$L = - \frac{1}{n} {\sum }_{i = 1}^{n} {q}_{i} \cdot k \qquad ( 1 )$$

In equation (1), n is the number of predictors 302. qᵢ is an output from the i-th (1≤i≤n) of the n predictors 302. k indicates an output of the target encoder 41. The loss function in equation (1) is an additive average of an inner product of an output of the predictor 302 and an output of the target encoder 41, but a loss function relating to a weighted average, in which an output of each predictor 302 is weighted and added, may be used. The training unit 104 updates the parameters of the machine learning model 30, i.e., a weight coefficient, bias, etc. relating to the network of the feature extractor 301 and the predictors 302, so that the loss function L is minimized. At this time, the parameters of the target encoder 41 are not updated.

The training unit 104 may also add to the loss function a term for a distance (Mahalanobis distance) between the output of each predictor 302 and an average output of the predictors 302-1 to 302-N, and update the parameters of the machine learning model so as to increase that distance. The training unit 104 may also add to the loss function a term that makes the output from each predictor 302 uncorrelated (whitening), and update the parameters of the machine learning model in a direction of increasing decorrelation. This variation in the output values from the predictors 302 increases the training effect of the ensemble.

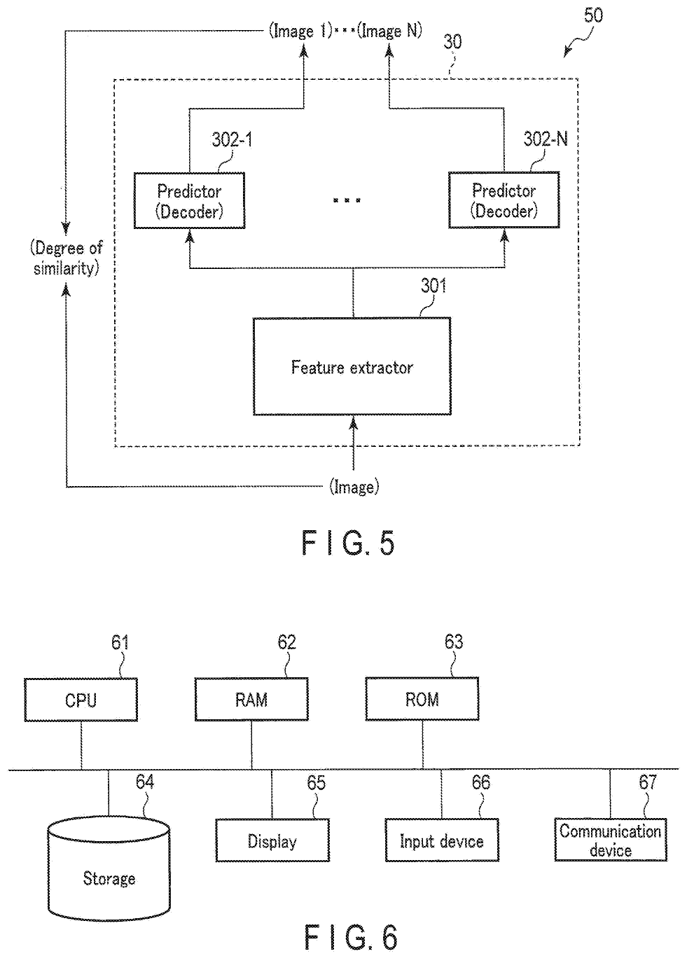

Next, a second example of the network structure when training of the machine learning model 30 is described with reference to FIG. 5.

A network structure 50 shown in FIG. 5 assumes an autoencoder in a case where the feature extractor 301 is an encoder and the predictors 302 are a plurality of decoders. Each of the predictors 302 in the network structure 50 may be composed of such a decoder network that recovers an input image from an image feature, which is an output of the feature extractor 301.

In training the machine learning model 30 using the network structure 50, for example, a degree of similarity between the input image and an output image (images 1 to N) from each predictor 302 may be used as a loss function, and the parameters of the machine learning model 30 may be updated so as to decrease a value of that loss function. That is, the training is performed such that the image output from the predictor 302 becomes closer to the input image.

In addition to the methods shown in FIGS. 4 and 5, training methods such as those used in general self-supervised learning may be applied to train the network structure 40 shown in FIG. 4 and the network structure 50 shown in FIG. 5. That is, the network structure for training the machine learning model 30 according to the present embodiment is not limited to the examples in FIGS. 4 and 5, but other training methods such as contrastive learning and rotation prediction may be applied.

In the examples described above, the predictors 302 are assumed to be stored in the storage 101 in advance, but the predictors 302 may be generated when training the machine learning model.

The generator 103 may generate a plurality of different predictors 302 based on one predictor 302, for example, by randomly setting at least one of weight coefficient, the number of layers of the network, the number of nodes, the number of dropouts, dropout position, regularization value, or the like.

Next, an example of a hardware configuration of the information processing apparatus 10 according to the above embodiment is shown in a block diagram of FIG. 6.

The information processing apparatus 10 includes a central processing unit (CPU) 61, a random-access memory (RAM) 62, a read-only memory (ROM) 63, a storage 64, a display 65, an input device 66, and a communication device 67, all of which are connected by a bus.

The CPU 61 is a processor that executes arithmetic processing, control processing, etc. according to a program. The CPU 61 uses a predetermined area in the RAM 62 as a work area to perform, in cooperation with a program stored in the ROM 63, the storage 64, etc., processing of each unit of the information processing apparatus 10 described above.

The RAM 62 is a memory such as a synchronous dynamic random-access memory (SDRAM). The RAM 62 functions as a work area for the CPU 61. The ROM 63 is a memory that stores programs and various types of information in a manner such that no rewriting is permitted.

The storage 64 is a magnetic storage medium such as a hard disc drive (HDD), a semiconductor storage medium such as a flash memory, or a device that writes and reads data to and from a magnetically recordable storage medium such as an HDD, an optically recordable storage medium, etc. The storage 64 writes and reads data to and from the storage media under the control of the CPU 61.

The display 65 is a display device such as a liquid crystal display (LCD). The display 65 displays various types of information based on display signals from the CPU 61.

The input device 66 is an input device such as a mouse and a keyboard. The input device 66 receives information input by an operation of a user as an instruction signal, and outputs the instruction signal to the CPU 61.

The communication device 67 communicates with an external device via a network under the control of the CPU 61.

According to the embodiment described above, a machine learning model that couples one feature extractor to a plurality of predictors is used, and training is performed by using a result of ensembling outputs of the predictors, thereby training the feature extractor. This can reduce memory and computational costs when training the model because the outputs of the predictors are ensembled, as compared to a case of ensemble learning with a plurality of encoders prepared. In addition, since the predictors are used when training but not at the time of inference, a model to be deployed to downstream tasks as a trained model is a feature extractor. Thus, memory and computational costs can be reduced even at the time of inference.

The instructions indicated in the processing steps in the embodiment described above can be executed based on a software program. It is also possible for a general-purpose computer system to store this program in advance and read this program to achieve the same effect as that of the control operation of the information processing apparatus described above. The instructions in the embodiment described above are stored, as a program executable by a computer, in a magnetic disc (flexible disc, hard disc, etc.), an optical disc (CD-ROM, CD-R, CD-RW, DVD-ROM, DVD±R, DVD±RW, Blu-ray (registered trademark) disc, etc.), a semiconductor memory, or a similar storage medium. The storage medium here may utilize any storage technique provided that the storage medium can be read by a computer or by a built-in system. The computer can realize the same operation as the control of the information processing apparatus according to the above embodiment by reading the program from the storage medium and, based on this program, causing the CPU to execute the instructions described in the program. Of course, the computer may acquire or read the program via a network.

Note that the processing for realizing the present embodiment may be partly assigned to an operating system (OS) running on a computer, database management software, middleware (MW) of a network, etc., according to an instruction of a program installed in the computer or the built-in system from the storage medium.

Further, each storage medium in the present embodiment is not limited to a medium independent of the computer or the built-in system. The storage media may include a storage medium that stores or temporarily stores the program downloaded via a LAN, the Internet, etc.

The number of storage media is not limited to one. The processes according to the present embodiment may also be executed with multiple media, where the configuration of each medium is discretionarily determined.

The computer or the built-in system in the present embodiment is intended for use in executing each process in the present embodiment based on a program stored in a storage medium. The computer or the built-in system may be of any configuration such as an apparatus constituted by a single personal computer or a single microcomputer, etc., or a system in which multiple apparatuses are connected via a network.

Also, the computer in the present embodiment is not limited to a personal computer. The “computer” in the context of the present embodiment is a collective term for a device, an apparatus, etc., which is capable of realizing the intended functions of the present embodiment according to a program and which includes an arithmetic processor in an information processing apparatus, a microcomputer, etc.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising a processor configured to:
generate a machine learning model by coupling one feature extractor to each of a plurality of predictors, the feature extractor being configured to extract a feature amount of data; and
train the machine learning model for a specific task using a result of ensembling a plurality of outputs from the predictors.

2. The apparatus according to claim 1, wherein the plurality of predictors differ in configuration.

3. The apparatus according to claim 1, wherein the plurality of predictors differ in at least one of weight coefficient, number of layers, number of nodes, or network structure.

4. The apparatus according to claim 1, wherein the plurality of predictors include dropouts so as to differ in network structure when training, or differ in at least one of number of dropouts, dropout position, or regularization value.

5. The apparatus according to claim 1, wherein if the plurality of predictors each include a convolutional layer, the plurality of predictors differ in position of a pooling layer.

6. The apparatus according to claim 1, wherein the processor is further configured to extract a feature extractor included in the machine learning model as a trained model upon completion of training of the machine learning model.

7. The apparatus according to claim 1, wherein the processor trains the machine learning model based on a loss function using an additive average or a weighted average of the outputs of the plurality of predictors.

8. The apparatus according to claim 1, wherein the processor trains the machine learning model so as to increase a distance between an output of each of the predictors and an average output of the plurality of predictors.

9. The apparatus according to claim 1, wherein the processor trains the machine learning model such that the outputs of the plurality of predictors are uncorrelated.

10. The apparatus according to claim 1, wherein the machine learning model includes a configuration in which noise is added to an output from the feature extractor to be input to each of the predictors.

11. An information processing method comprising:
generating a machine learning model by coupling one feature extractor to each of a plurality of predictors, the feature extractor being configured to extract a feature amount of data; and
training the machine learning model for a specific task using a result of ensembling a plurality of outputs from the predictors.

12. A non-transitory computer readable medium including computer executable instructions, wherein the instructions, when executed by a processor, cause the processor to perform a method comprising:
generating a machine learning model by coupling one feature extractor to each of a plurality of predictors, the feature extractor being configured to extract a feature amount of data; and
training the machine learning model for a specific task using a result of ensembling a plurality of outputs from the predictors.
